(19) United States
(12) Patent Application Publication
(10) Pub. No.: US 2015/0318612 A1
(43) Pub. Date: Nov. 5, 2015

(54) Method and Apparatus for Wideband, Polarimetric Reception of High Frequency Radio Signals

(71) Applicant: Lars Karlsson, Santa Clara, CA (US)

(72) Inventor: Lars Karlsson, Santa Clara, CA (US)

(21) Appl. No.: 13/681,313

(22) Filed: Nov. 19, 2012

(51) Int. Cl. H01Q 7/00; H01Q 21/00; H01Q 1/50

(52) U.S. Cl. CPC H01Q 7/00; H01Q 1/50; H01Q 21/0006

(57) ABSTRACT

A Method and Apparatus for Wideband, Polarimetric Reception of High Frequency Radio Signals. Traditionally, high frequency (HF) antennas that employ magnetic loops are “tuned” to specific frequency and a single polarization. Modern processing equipment is capable of handling large bandwidths and requires sensitivity for all polarizations at all elevation angles. As a result of these needs, this invention provides an HF antenna that is both wideband and polarimetric. The antenna presented here is sensitive to both linear vertical and horizontal polarizations as well as to circular polarizations for high elevation angles. This makes it optimal as an element in a direction finding array. The antenna should be modular in construction so that it is easily deployed and packed for transport.

This application is filed within one year of, and claims priority to Provisional Application Ser. No. 61/562,072, filed Nov. 21, 2011.

### BACKGROUND OF THE INVENTION

1. Field of the Invention

This invention relates generally to electronic emission direction finding systems and, more specifically, to a Method and Apparatus for Wideband, Polarimetric Reception of High Frequency Radio Signals.

2. Description of Related Art

This patent application describes a wideband, high sensitivity, polarimetric, triple-loop antenna for receiving high frequency (HF) radio signals. Such an antenna will find great utility as an element in a HF direction finding array.

Frequencies within the high frequency (HF) band are often used for medium to long-range radio communications. Some of the appeal of the HF band lies in its long range capability made possible by refraction of these frequencies in the ionosphere; a process called skywave propagation. Signals coming from these lower elevations can be arbitrarily polarized so it is desirable that the receiving antenna is able to simultaneously receive several polarizations (i.e. that it be polarimetric). There is a propagation mode called NVIS (Near Vertical Incidence Skywave) where the signals are coming from very high elevations with completely undefined polarizations.

FIG. 1 is a perspective view of the 3-element antenna 11 of U.S. Pat. No. 4,433,336 to Carr. The Carr reference outlines an example of an antenna capable of receiving two polarizations. The Carr antenna is a combination of a cross-loop antenna (having first and second loops antennas 14A, 14B) mounted to the top of a monopole whip antenna 12. While the Carr antenna 11 is capable of receiving both horizontal and vertical polarizations, it is severely limited in its utility for today's electronic emissions environment. First, the Carr antenna 11 is limited to a strictly narrow bandwidth. While it can be tuned to a desired frequency band, it is not possible (with a single Carr antenna) to conduct surveillance on a wide frequency spectrum—a feature which is critical in today's electronic warfare environment. Second, because receipt of the horizontal polarization is conducted from a monopole whip antenna, there is a built-in disparity between the signals received from it and the cross-loop (vertical polarization-receiving) antenna. This disparity is fatal to the ultimate effectiveness of the antenna at collection of signals and their polarization as a tool for in-depth analysis of this signal and polarization information. Since the horizontal polarization and vertical polarization components are being received by different types of antennas, there must be some calibration scheme in order to attempt to establish consistent amplitude in the two signal components.

What is needed, then, is a wide-band polarimetric antenna that is capable of high sensitivity, innately calibrated reception of polarimetric signal data.

### SUMMARY OF THE INVENTION

In light of the aforementioned problems associated with the prior devices and methods, it is an object of the present invention to provide a Method and Apparatus For Wideband, Polarimetric Reception of High Frequency Radio Signals. Traditionally, high frequency (HF) antennas that employ magnetic loops are “tuned” to specific frequency and a single polarization. Modern processing equipment is capable of handling large bandwidths and requires sensitivity for all polarizations at all elevation angles. As a result of these needs, this invention seeks to provide an HF antenna that is both wideband and polarimetric. The antenna presented here should be sensitive to both linear vertical and horizontal polarizations as well as circular polarizations for high elevation angles. This would make it optimal as an element in a direction finding array. The antenna may further be modular in construction so that it is easily deployed and packed for transport.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 shows the prior art antenna of Carr, U.S. Pat. No. 4,433,336;

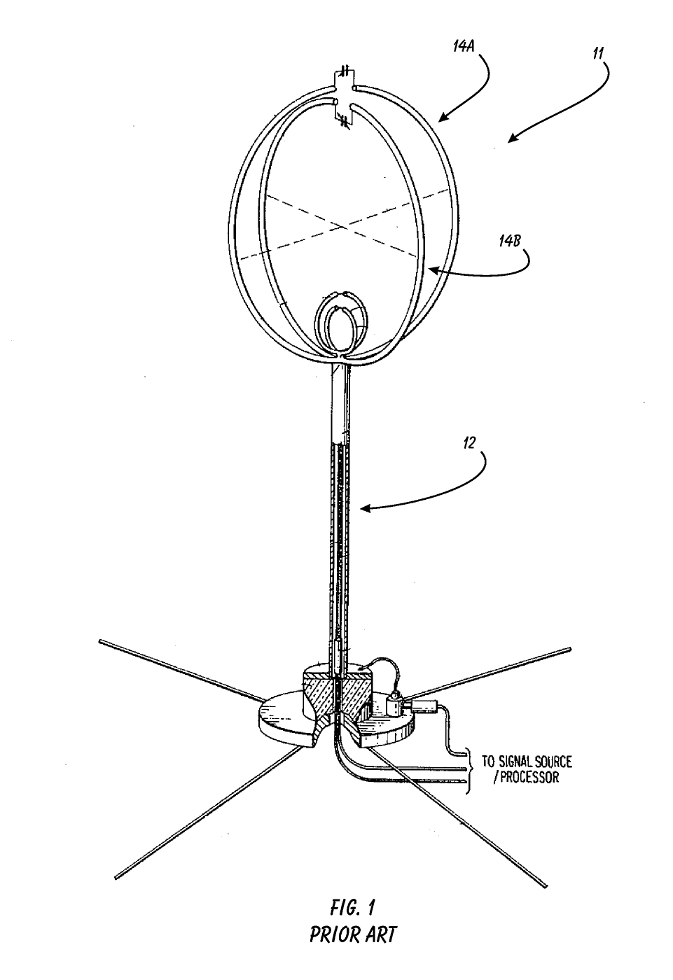

FIG. 2 shows an example of a negative impedance converter;

FIG. 3 shows a physical diagram of a preferred embodiment of the antenna and its components of the present invention; and

FIG. 4 shows an exploded view of the antenna of FIG. 3.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Method and Apparatus for Wideband, Polarimetric Reception of High Frequency Radio Signals.

The current invention of this application offers several important improvements and advances beyond the prior art. One innovative improvement is the ability to receive all polarizations with exactly the same sensitivity for all frequencies. A second improvement is that a much larger frequency range covering several octaves (for example 100 KHz to 30 MHz can be covered with one antenna). Another unique aspect of this invention is its small physical dimensions and its ease of setup and breakdown. The small dimensions allow it to be portable and it requires very little effort to unfold and install. Both of these features are important for military requirements.

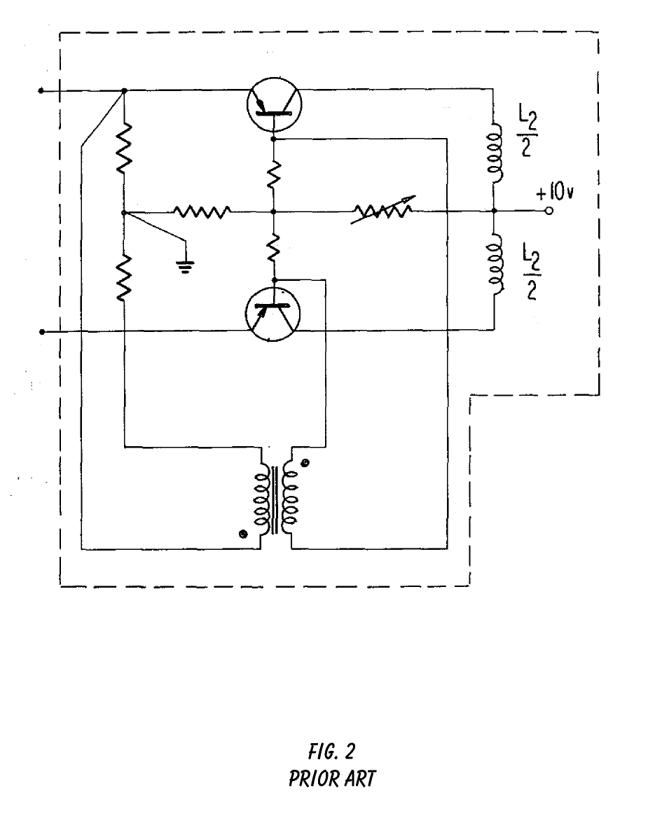

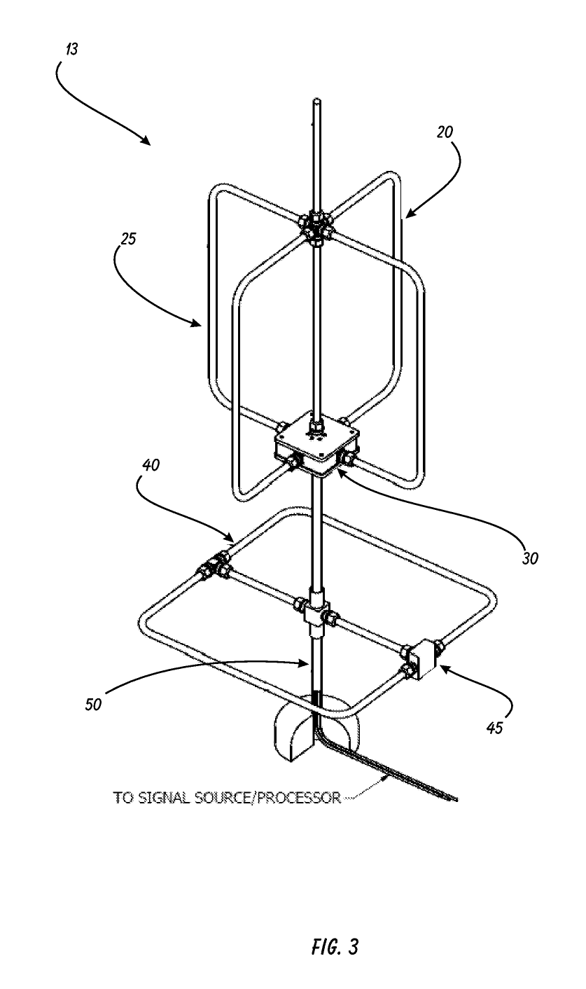

The present invention can best be understood by initial consideration of FIGS. 2 and 3.¹ FIG. 3 is a perspective view of a preferred embodiment of the triple-loop antenna 13 of the present invention. The electrical outputs of the antenna matching networks are attached via electrical connectors to a set of HF receivers (not shown). ¹ As used throughout this disclosure, element numbers enclosed in square brackets [ ] indicates that the referenced element is not shown in the instant drawing figure, but rather is displayed elsewhere in another drawing figure.

### DIAGRAM REFERENCE NUMERALS

10 Lightning Rod
13 triple-loop antenna apparatus
20 Vertical N-S Element
25 Vertical E-W Element
30 Matching Networks for the vertical loops
40 Horizontal Element
45 Matching Network for the horizontal loop
50 Mounting Mast

Operation

The horizontal loop 40 and the vertical loops 20 and 25 consist of one “turn” built out of lightweight aluminum pipe. To maintain a good and consistent antenna pattern the circumference of the loops should not be larger than 30% of the wavelength at the desired maximum frequency to be analyzed. All three loops are grounded in the center to provide lightning protection and a balanced feed point. With this arrangement all local common mode noise will also be cancelled without the requirement for additional shielding. The loops 20, 25 and 40 metal parts all have the same dimensions and are in fact interchangeable. Every loop is connected to its own matching network (30 and 45). For those cases where a single cable (vs two cables) is desired from the vertical elements 20, 25, the outputs from the two vertical matching networks can also be combined with help of a 90 degree hybrid attached to the matching network 30. This will give good sensitivity to signals of any polarization coming from high elevations. The matching networks are designed to provide wide frequency bandwidth while having very small dimensions.

In order to achieve this level of sensitivity, it is preferred that the matching networks consist of negative impedance converters, an example of which is depicted in FIG. 2. These negative impedance converters are utilized to cancel the inductance and most of the resistance in the antenna loop element (a so called non-Foster matching network). A further example of a negative impedance converter used for a loop element is outlined in U.S. Pat. No. 3,953,799: “Broadband VLF Loop Antenna System” by Thomas K Albee. As it is well-known, for the purposes of the description provided herein, it is assumed that the function of negative impedance converters is understood, and therefore the design is incorporated herein by reference.

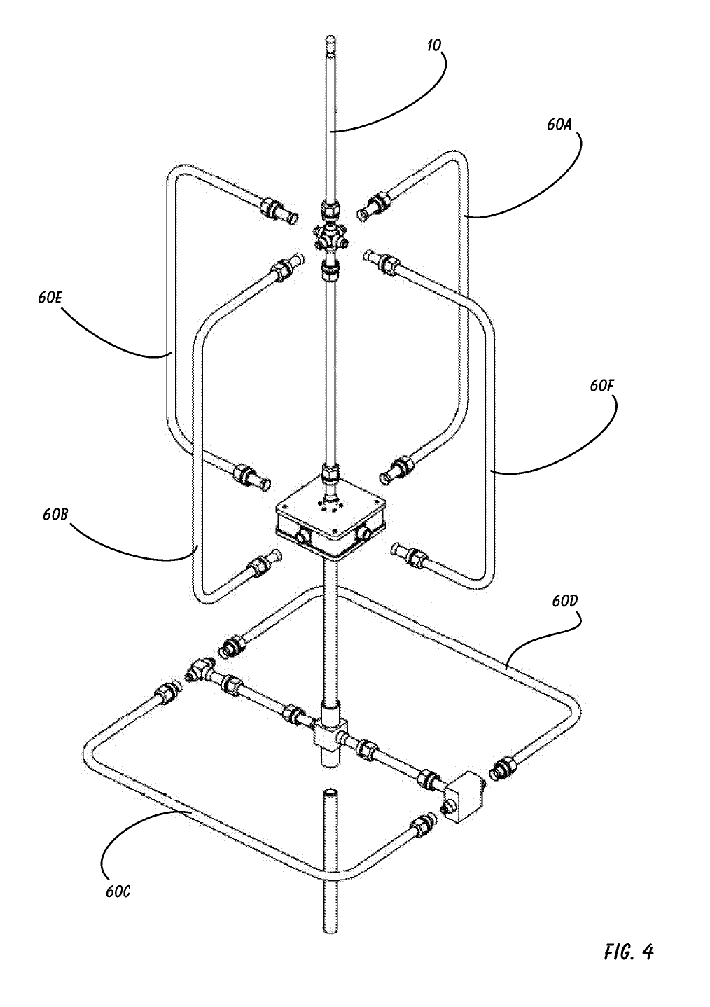

Returning to FIG. 3, a lightning rod 10, can also be attached and the bottom piece may be a grounded mounting mast 50 for various mounting possibilities. The antenna 13 has been mechanically designed so that it can be quickly set up or torn down without specialized tools or personnel (see FIG. 4). When the antenna 13 is disassembled, it will fit in a flat package for shipping.

As clearly depicted in FIG. 4, a critical feature of the antenna 13 of the present invention is that it has two vertical loops [20, 25] and one horizontal loop [40] that are all made from identical sub-elements. Specifically, these loops [20, 25 and 40] are each made up from a pair of matching semi-loops (collectively 60). Loop [20] is made up of first and second semi-loop elements 60A, 60B. Loop [25] is made up of third and fourth semi-loop elements 60C, 60D. Loop [40] is made up of fifth and sixth semi-loop elements 60E and 60F. These semi-loops 60 are completely interchangeable, and are attachable and detachable via the threaded nuts located at the ends of each.

The benefit of the loops [20, 25, 40] being identical in configuration is that, unlike the antennas of the prior art systems, the horizontal wave polarity and vertical wave polarity are received by identical loops in virtually identical locations. This means that the signal data for both polarities is on the identical amplitude scale (or off by a constant multiplier). The Carr antenna is not capable of the same accuracy and sensitivity because its two polarities are being received by antennas of radically different design. The antenna [13], therefore, may be referred to as being “self-calibrated,” because no calibration scheme is necessary in order to obtain signal polarity in both horizontal and vertical (and therefore also circular) realms.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An antenna assembly, comprising:
a first antenna loop having a closed loop oriented in a first flat spatial plane;
a second antenna loop having a closed loop oriented in a second flat spatial plane, said first and second spatial planes in relative perpendicular orientation along a first axis; and
a third antenna loop having a closed loop oriented in a third flat spatial plane, said third spatial plane in relative perpendicular orientation to said first axis.

2. The antenna assembly of claim 1, wherein said first antenna loop, said second antenna loop and said third antenna loop each comprise a pair of semi-loop elements, with all said semi-loop elements being essentially identical.

3. The antenna assembly of claim 2 further comprising a mounting mast extending along said first axis from said first and second antenna loops and through a point defined by the geometrical center of said third antenna loop.

4. The antenna assembly of claim 3, further comprising a lightning rod extending along said first axis from said first and second antenna loops opposite to said mounting mast.

5. The antenna assembly of claim 4, further comprising a first matching network device attached to said mounting mast, said first antenna loop and said second antenna loop.

6. The antenna assembly of claim 5, further comprising a second matching network device attached to said third antenna loop between the semi-loop elements.

7. A method for receiving wireless electronic signals, comprising the steps of:
receiving incident wireless electronic signals at a triple-loop antenna assembly, said triple-loop antenna assembly comprising:
a first antenna loop having a closed loop oriented in a first flat spatial plane;
a second antenna loop having a closed loop oriented in a second flat spatial plane, said first and second spatial planes in relative perpendicular orientation along a first axis; and
a third antenna loop having a closed loop oriented in a third flat spatial plane, said third spatial plane in relative perpendicular orientation to said first axis.

8. The method of claim 7, further comprising:
transferring said received electronic signals to signal source processing devices, said receiving and said transferring being conducted without adjusting the amplitude of said received electronic signals.

9. The method of claim 8, wherein said first antenna loop, said second antenna loop and said third antenna loop of said triple-loop antenna assembly of said receiving step each comprise a pair of semi-loop elements, with all said semi-loop elements being essentially identical.

10. The method of claim 9, wherein said triple-loop antenna assembly of said receiving step comprises a mounting mast extending along said first axis from said first and second antenna loops and through a point defined by the geometrical center of said third antenna loop.

11. The method of claim 10, wherein said triple-loop antenna assembly of said receiving step comprises a lightning rod extending along said first axis from said first and second antenna loops opposite to said mounting mast.

12. The method of claim 11, wherein said triple-loop antenna assembly of said receiving step comprises a first matching network device attached to said mounting mast, said first antenna loop and said second antenna loop.

13. The method of claim 12, wherein said triple-loop antenna assembly of said receiving step comprises a second matching network device attached to said third antenna loop between the semi-loop elements.

14. An antenna assembly, comprising:
a first antenna loop, the shape of which defines a first loop profile;
a second antenna loop, the shape of which defines said first loop profile;
a third antenna loop, the shape of which defines said first loop profile; and
wherein said first, second and third antenna loops are oriented along a central axis.

15. The antenna assembly of claim 14, wherein said first loop profile defines a substantially planar orientation.

16. The antenna assembly of claim 15, wherein said first and second antenna loops intersect each other along said central axis.

17. The antenna assembly of claim 16, wherein said third antenna loop is attached to said assembly along said central axis such that its planar orientation is perpendicular to said central axis.
